(19) United States
(12) Patent Application Publication
(10) Pub. No.: US 2023/0036124 A1
(43) Pub. Date: Feb. 2, 2023

(54) CROSS-LINKED EPOXY-CONTAINING ETHYLENE INTERPOLYMER FOAMS

(71) Applicant: Dow Global Technologies LLC, Midland, MI (US)

(72) Inventors: Jinliang Yan, Shanghai (CN); Haiyang Yu, Shanghai (CN); Xian Jiang, Lake Jackson, TX (US); Bo Lyu, Shanghai (CN); Hong Yang, Shanghai (CN)

(73) Assignee: Dow Global Technologies LLC, Midland, MI (US)

(21) Appl. No.: 17/788,593

(22) PCT Filed: Dec. 21, 2020
(86) PCT No.: PCT/US2020/066297

§ 371 Date: Jun. 23, 2022

Related U.S. Application Data
(63) Continuation of application No. PCT/CN2019/127927, filed on Dec. 24, 2019.

(51) Int. Cl. C08J 9/10; C08K 3/24

(52) U.S. Cl. CPC C08J 9/103; C08K 3/24; C08J 2203/04; C08J 2201/026; C08J 2323/08; C08K 2201/019

(57) ABSTRACT

A foam is formed from a composition comprising at least 40 wt. % of an E/X/Y/Z epoxy-containing ethylene interpolymer, where E is an ethylene monomer comprising greater than 50 wt. % of the interpolymer, X is an (meth)acrylate, alkyl (meth)acrylate, or vinyl acetate comprising from 0 to 40 wt. % of the interpolymer, Y is glycidyl methacrylate and comprises 0.5 to 15 wt. % of the interpolymer, and Z is a copolymer unit derived from comonomers selected from the group consisting of carbon monoxide, sulfur dioxide, and acrylonitrile and comprises from 0 to 10 wt. % of the interpolymer; from 0.1 wt. % to 10 wt. % of a chemical blowing agent; from 0.1 wt. % to 10 wt. % of an activator; and less than 0.05 wt. % of a curing agent.

### CROSS REFERENCE TO RELATED APPLICATIONS

This application claims priority to International Patent Application No. PCT/CN2019/127927, filed on Dec. 24, 2019, the entire disclosure of which is hereby incorporated by reference

### FIELD

Embodiments of the present disclosure are generally related to ethylene interpolymer foams, and are more specifically related to cross-linked epoxy-containing ethylene interpolymer foams.

### BACKGROUND

Conventional midsole foam formulations for applications such as athletic shoes contain base polymers such as ethyl vinyl acetate copolymers (EVA), polyolefin elastomers (POE), olefin block copolymers (OBC) and ethylene-propylene-diene-monomer copolymers (EPDM) and additives including crosslinking agents. Although crosslinking agents enable desirable final foam properties, commonly used crosslinking agents include peroxides, which are not environmentally friendly. Additionally, peroxide and its decomposition produces can have a bad smell, migration, and mold pollution, and require special treatment for transportation and storage.

Accordingly, there is a need for alternative ethylene copolymer foams with good foam properties without the use of peroxides.

### SUMMARY

Embodiments of the present disclosure meet this need by providing a cross-linked foam that exhibits similar foam properties as peroxide crosslinked while exhibiting improved heat shrinkage and processing advantages like lower foaming temperature, shorter foaming time. According to one or more embodiments herein, a foam is formed from a composition comprising at least 40 wt. % of an E/X/Y/Z epoxy-containing ethylene interpolymer; from 0.1 wt. % to 10 wt. % of a chemical blowing agent; from 0.1 wt. % to 10 wt. % of an activator; and less than 0.05 wt. % of a curing agent. In the E/X/Y/Z epoxy-containing interpolymer, E is an ethylene monomer comprising greater than 50 wt. % of the interpolymer, X is an (meth)acrylate, alkyl (meth)acrylate, or vinyl acetate comprising from 0 to 40 wt. % of the interpolymer, Y is glycidyl methacrylate and comprises 0.5 to 15 wt. % of the interpolymer, and Z is a copolymer unit derived from comonomers selected from the group consisting of carbon monoxide, sulfur dioxide, and acrylonitrile and comprises from 0 to 10 wt. % of the interpolymer.

### DETAILED DESCRIPTION

In various embodiments described herein, a composition for forming a foam includes an E/X/Y/Z epoxy-containing ethylene interpolymer, a chemical blowing agent, an activator, and less than 0.05 wt. % of a curing agent. Such embodiments enable the formation of a foam having good foam properties without the use of peroxides, as will be described in greater detail below.

As used herein, the term “composition” and like terms mean a mixture of two or more materials, such as a polymer which is blended with other polymers or which contains additive, fillers, or the like. Included in compositions are pre-reaction, reaction, and post-reaction mixtures, the latter of which will include reaction products and by-products as well as unreacted components of the reaction mixture and decomposition products, if any, formed from the one or more components of the pre-reaction or reaction mixture.

“Polymer” means a compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, and the like. The terms “ethylene/alpha-olefin polymer” and “propylene/alpha-olefin polymer” are indicative of interpolymers as described below. It is noted that although a polymer is often referred to as being “made of” monomers, “based on” a specified monomer or monomer type, “containing” a specified monomer content, or the like, this obviously understood to be referring to the polymerized remnant of the specified monomer and not to the unpolymerized species.

“Interpolymer” means a polymer prepared by the polymerization of at least two different monomers. This generic term includes copolymers, usually employed to refer to polymers prepared from two or more different monomers, and includes polymers prepared from more than two different monomers, e.g., terpolymers, tetrapolymers, and the like.

“Polyolefin,” “polyolefin polymer,” “polyolefin resin,” and like terms mean a polymer produced from a simple olefin (also called an alkene with the general formula CₙH₂ₙ) as a monomer. Polyethylene is produced by polymerizing ethylene with or without one or more comonomers, polypropylene by polymerizing propylene with or without one or more comonomers, and the like. Thus, polyolefins include interpolymers such as ethylene-alpha-olefin copolymers, propylene-alpha-olefin copolymers, and the like.

“(Meth)acrylic acid” includes methacrylic acid and/or acrylic acid and “(meth)acrylate” includes methacrylate and/or acrylate.

“Foam” and like terms mean a substance that is formed by trapping many gas bubbles in a liquid or solid.

Various embodiments described herein include at least 50 parts per hundred rubber (phr) of an E/X/Y/Z epoxy-containing ethylene interpolymer, based on the total weight of the polymers in the composition, where E is an ethylene monomer, X is an (meth)acrylate, alkyl (meth)acrylate, or vinyl acetate, Y is glycidyl methacrylate (GMA), and Z is a copolymer unit derived from comonomers selected from the group consisting of carbon monoxide, sulfur dioxide, and acrylonitrile and comprises from 0 to 10 wt. % of the interpolymer. In various embodiments, the polymer composition includes at least 40 wt. % of the E/X/Y/Z epoxy-containing ethylene interpolymer, or at least 50 wt. % of the E/X/Y/Z epoxy-containing ethylene interpolymer, based on the total weight of the polymer composition. As used herein, “epoxy-containing ethylene interpolymer” means a first embodiment wherein the epoxy composition may be copolymerized with the ethylene into the interpolymer backbone, for example, through an epoxy containing monomer like GMA. Additionally, “epoxy-containing ethylene interpolymer” may encompass a second embodiment wherein the epoxy is grafted onto the interpolymer backbone. Moreover, the “epoxy-containing ethylene interpolymer” could encompass a combination of the first and second embodiments.

The ethylene can be present in an amount of greater than 50 wt. %, based on the total weight of polymerizable monomers. For example, the epoxy-containing ethylene interpolymer can include from 50 wt. % to 99.5 wt. % ethylene, from 55 wt. % to 94 wt. % ethylene, from 60 wt. % to 90 wt. % ethylene, or from 65 wt. % to 85 wt. % ethylene. All individual values and subranges from 50 wt. % to 99.5 wt. % are included.

In embodiments, the X component can be present in an amount of from 0 wt. % to 40 wt. %, based on the total weight of polymerizable monomers. For example, the X component may be present in an amount from 1 wt. % to 40 wt. %, from 12 wt. % to 32 wt. %, or from 13 wt. % to 31 wt. %, based on the total weight of the polymerizable monomers. All individual values and subranges from 0 wt. % to 40 wt. % are included. In embodiments, X may be a copolymer unit —(CH₂CR¹R²)—. In some embodiments, R¹ may be hydrogen, methyl, or ethyl. In some embodiments, R² is carboalkoxy, acyloxy, or alkoxy of 1 to 10 carbon atoms. As described above, in various embodiments, X is an (meth)acrylate, alkyl (meth)acrylate, or vinyl acetate. Suitable acrylate comonomers include methyl acrylate (MA), ethyl acrylate (EA), and butyl acrylate (BA).

In embodiments, Y may be a copolymer unit —(CH₂CR³R⁴)—. In some embodiments, R³ may be hydrogen or methyl. In some embodiments, R⁴ may be carboglycidoxy or glycidoxy. In some embodiments, Y may be selected from the group consisting of glycidyl acrylate, glycidyl methacrylate, glycidyl butyl acrylate, glycidyl vinyl ether, and combinations of two or more of glycidyl acrylate, glycidyl methacrylate, glycidyl butyl acrylate, and glycidyl vinyl ether. The epoxy-containing ethylene interpolymer of various embodiments includes from 0.5 wt. % to 15 wt. %, or from 5 wt. % to 10 wt. % of glycidyl methacrylate (GMA), based on the total weight of polymerizable monomers. Without being bound by theory, it is believed that the epoxy monomer present in the GMA cross-links with the azo group of the blowing agent or an ammonia decomposition product of the blowing agent to yield the cross-linked foam, which is resistant to foaming expansion. Additionally, it is believed that the cross-linking between the GMA and the azo or ammonia group enables the strong cross-linked foam to be achieved without the need for a peroxide crosslinker.

In embodiments, Z may be a copolymer unit derived from comonomers including carbon monoxide, sulfur dioxide, acrylonitrile, or other monomers. In further embodiments, the epoxy-functionalized ethylene copolymer may include from about 0 wt. % to about 10 wt. % Z, from about 0 wt. % to about 8 wt. % Z, from about 0 wt. % to about 6 wt. % Z, from about 0 wt. % to about 4 wt. % Z, from about 0 wt. % to about 2 wt. % Z, from about 2 wt. % to about 10 wt. % Z, from about 2 wt. % to about 8 wt. % Z, from about 2 wt. % to about 6 wt. % Z, from about 2 wt. % to about 4 wt. % Z, from about 4 wt. % to about 10 wt. % Z, from about 4 wt. % to about 8 wt. % Z, from about 4 wt. % to about 6 wt. % Z, from about 6 wt. % to about 10 wt. % Z, from about 6 wt. % to about 8 wt. % Z, or from about 8 wt. % to about 10 wt. % Z, based on the total weight of polymerizable monomers.

It is contemplated that some embodiments include 0 wt. % of Z. In such embodiments, the epoxy-containing ethylene interpolymer may be referred to as an E/X/Y epoxy-containing ethylene interpolymer.

The epoxy-containing ethylene interpolymer may have a melt index (I2) of from 0.5 to 20 g/10 min, from 4 to 20 g/10 min, from 4 to 15 g/10 min, from 4 to 12 g/10 min, or from 5 to 10 g/10 min, as determined in accordance with ASTM D1238 (190° C.; 2.16 kg). Examples of commercially available copolymer resins which may be used in some embodiments include those available under the trade name ELVALOY™, available from The Dow Chemical Company (Midland, Mich.).

According to various embodiments, the composition further includes a chemical blowing agent to generate porosity to form the foam upon heating. The chemical blowing agent may comprise a nitrogen-containing composition or generate an ammonia after decomposition, which may crosslink with the epoxy group of the epoxy-containing ethylene interpolymer. In general, the amount of blowing agent is an amount effective to produce a fairly uniform cell size in the foam. In various embodiments, the blowing agent is present in an amount of from 0.1 wt. % to 30 wt. %, from 0.1 wt. % to 10 wt. %, from 0.5 wt. % to 5 wt. %, or from 1 wt. % to 3 wt. %, based on the total weight of the composition. In various embodiments, the blowing agent is a chemical blowing agent which decomposes to liberate gases (e.g., azo compounds or other nitrogen-containing compounds, such as ammonia) during the blowing process to form a foam. The one or more azo compounds or other nitrogen-containing compounds that are liberated by the chemical blowing agent react with the GMA of the epoxy-containing ethylene interpolymer to produce a cross-linked epoxy-containing ethylene interpolymer. As described above and below, this cross-linking enables the production of a strong foam with resistance to expansion without the use of a peroxide crosslinker.

Chemical blowing agents include azobisisobutyronitrile (AIBN), azodicarbonamide, dinitroso-pentamethylene-tetramine, p-toluene sulfonyl hydrazide, p,p′-oxy-bis(benzenesulfonyl hydrazide), and combinations thereof. An exemplary azo compound is azodicarbonamide. Commercially available chemical blowing agents suitable for use include Azodicarbonamide AC 6000 HG, available from Haihong Chemical, and Azodicaronamide ACP-H, available from Haili Chemicals. In order to tailor expansion-decomposition temperature and foaming processes, a blowing agent may also be a mixture of blowing agents or of blowing agents and an activator.

In various embodiments, the composition used to produce the foam includes from 0.05 wt. % to 15 wt. %, from 0.1 wt. % to 10 wt. %, from 0.1 wt. % to 1 wt. %, or from 0.2 wt. % to 0.4 wt. % of an activator, based on the total weight of the composition. The activator lowers the decomposition temperature/profile of the blowing agents. In various embodiments, the activator is a metal stearic acid salt, such as zinc stearate. In embodiments, the activator is one or more metal oxides, metal salts, or organometallic complexes, or a combination thereof. Examples of suitable activators include zinc oxide, magnesium oxide, zinc stearate, calcium stearate, iron stearate, or combinations thereof. Other examples of suitable activators include imidazole, tertiary amines, Lewis acids, boron trifluoride, and other well-known catalysts suitable for use in epoxy-amine curing processes. Without being bound by theory, it is believed that the activator helps to regulate the temperature at which the blowing agent is activated to generate the gas(es) that foams the composition to the desired thickness and/or density reduction.

In various embodiments, the composition comprises less than 0.05 wt. % of a curing agent, based on the total weight of the composition. Curing agents include one or more organic peroxides including dialkyl peroxides, peroxy esters, peroxy dicarbonates, peroxy ketals, diacyl peroxides, or combinations of two or more thereof. Examples of peroxides include dicumyl peroxide, di(3,3,5-trimethyl hexanoyl)peroxide, t-butyl peroxypivalate, t-butyl peroxyneodecanoate, di(§ -butyl)peroxydicarbonate, t-amyl peroxyneodecanoate, 1,1-di-t-butyl peroxy-3,3,5-trimethylcyclohexane, t-butyl-cumyl peroxide, 2,5-dimethyl-2,5-di(tertiary-butyl-peroxyl)hexane, 1,3-bis(tertiary-butyl-peroxyl-isopropyl)benzene, or a combination thereof. Commercially available curing agents include those available under the trade names LUPEROX® from Arkema or TRIGONOX® from Akzo Nobel. However, in other embodiments, the composition is free of peroxides.

Other additives, which can be present in the composition from 0 wt. % to 30 wt. %, from 0 wt. % to 20 wt. %, from 0 wt. % to 12 wt. %, or from 0 wt. % to 5 wt. %, based on the total weight of the composition, may include pigments (TiO₂ and other compatible colored pigments), fillers (e.g., talc, calcium carbonate, barium sulfate, and/or silicon oxide), stabilizers (e.g., antioxidants, UV absorbers, and/or flame retardants), and processing aids (e.g., calcium stearate and/or barium stearate). Additionally or alternatively, in embodiments, the composition may further include one or more polymeric modifiers, such as ethylene vinyl acetate (EVA), polyolefin elastomer (POE), olefin block copolymer (OBC), ethylene propylene diene monomer (EPDM), styrene-ethylene-butylene-styrene elastomer (SEBS), or the like. When included, the polymeric modifiers can be present in the composition from 0 wt. % to 50 wt. %, from 0 wt. % to 30 wt. %, from 0 wt. % to 20 wt. %, from 0 wt. % to 12 wt. %, or from 0 wt. % to 5 wt. %, based on the total weight of the composition.

In various embodiments, the composition can be used to form a foam or molded article. For example, in embodiments, the epoxy-containing ethylene interpolymer can be combined with the chemical blowing agent, activator, curing agent, and additives (if any) to form foams of various shapes. In some embodiments, the foam may be extruded, such as from a twin screw extruder, as is known to those of ordinary skill in the art. In embodiments, the foam may be formed by compression molding, injection molding, or hybrids of extrusion and molding. The components may be mixed and blended using any technique known and used in the art, including Banbury, intensive mixers, two-roll mills, and extruders. Time, temperature, and shear rate can be regulated to ensure dispersion without premature crosslinking or foaming.

After mixing, shaping can be carried out. Sheeting rolls or calendar rolls can be used to make appropriately dimensioned sheets for foaming. An extruder may be used to shape the composition into pellets.

Foaming can be carried out in a compression mold at a temperature and time to complete the decomposition of the chemical blowing agent and curing agents. Pressures, molding temperature, and heating time can be controlled. Foaming can be carried out using injection molding equipment by using pellets made from the foam composition. The resulting foam can be further shaped to the dimension of finished products by any means known and used in the art, including thermoforming and compression molding.

In various embodiments, the resulting foam composition can be substantially closed cell and useful for a variety of articles, including but not limited to footwear applications including unitsoles, outsoles, midsoles or insoles.

In various embodiments, the resultant interpolymer foam has a compression set of less than 65%, or from 45% to 60%, as measured in accordance with ASTM D395. In various embodiments, the foam exhibits a heat shrinkage at 70° C. for 40 minutes of less than 0.5%.

### Test Methods

The foaming expansion ratio was calculated according to the following equation:

$$Foaming expansion ratio ( \% ) = \frac{thickness after foaming}{thickness before foaming} * 100$$

The density was measured in accordance with ASTM D792, and is reported in g/cc.

Hardness was measured in accordance with ASTM D2240, and is reported on the Asker C scale.

Resilience was measured in accordance with ASTM D7121, and is reported in percent (%).

Compression set was measured in accordance with ASTM D395, and is reported in percent (%).

Heat shrinkage was measured after heating the foam at 70° C. for 40 minutes and is reported in percent (%).

Split tear was measured in accordance with ASTM D3574, and is reported in Newtons per millimeter (N/mm).

Tensile strength was measured in accordance with ASTM D638, Type IV, and is reported in megapascals (MPa).

Tensile elongation was measured in accordance with ASTM D638, Type IV, and is reported in percentage (%).

Tear strength was measured in accordance with ASTM D624, Type C, and is reported in Newtons per millimeter (N/mm).

### Examples

The following examples are provided to illustrate various embodiments, but are not intended to limit the scope of the claims. All parts and percentages are by weight unless otherwise indicated. Approximate properties, characters, parameters, etc., are provided below with respect to various working examples, comparative examples, and the materials used in the working and comparative examples. Further, a description of the raw materials used in the examples is as follows:

ELVAX™ EP2288 is an ethylene vinyl acetate copolymer having a density of 0.940 g/cc, as measured in accordance with ASTM D792, a melt index (I2) of 2.2 g/10 min, as measured in accordance with ASTM D1238 at 190° C./2.16 kg, and a melting point (Tₘ) of 83° C.;

E/X/Y/Z-1 is an E/X/Y/Z epoxy-containing interpolymer having an nBA content of 21 wt. % and a GMA content of 9 wt. % and a melt index (I2) of 8.0 g/10 min, as measured in accordance with ASTM D1238 at 190° C./2.16 kg;

E/X/Y/Z-2 is an E/X/Y/Z epoxy-containing interpolymer having a vinyl acetate content of 15.3 wt. % and a GMA content of 9 wt. % and a melt index (I2) of 8.0 g/10 min, as measured in accordance with ASTM D1238 at 190° C./2.16 kg;

E/X/Y/Z-3 is an E/X/Y/Z epoxy-containing interpolymer having a vinyl acetate content of 20 wt. % and a GMA content of 5.25 wt. % and a melt index (I2) of 12.0 g/10 min, as measured in accordance with ASTM D1238 at 190° C./2.16 kg;

ACP-H is an azodicarbonamide blowing agent available from Haili Chemicals;

AC3000 is an azodicarbonamide blowing agent available from Haihong Chemical;

Talc is JINGHUA SK-6500 talc available from HaiCheng JingHua Mineral Products Co., Ltd (Liaoning, China) with a 1250 mesh diameter; and

BIPB is a crosslinking peroxide agent.

Six foaming compositions, Comparative Example A and Examples 1-5, were prepared according to the formulations (provided in wt. %) in Table 1 below.

TABLE 1
Table 1: Foaming Compositions

| | Comparative | Example | Example | Example | Example | Example |
|---|---|---|---|---|---|---|
| | Example A | 1 | 2 | 3 | 4 | 5 |
| ELVAX ™ | 87.99 | 0.00 | 0.00 | 43.67 | 22.03 | 0.00 |
| EP2288 | | | | | | |
| E/X/Y/Z-1 | 0.00 | 88.11 | 0.00 | 0.00 | 0.00 | 0.00 |
| E/X/Y/Z-2 | 0.00 | 0.00 | 88.89 | 43.67 | 66.08 | 0.00 |
| E/X/Y/Z-3 | 0.00 | 0.00 | 0.00 | 0.00 | 0.00 | 87.37 |
| AC 6000 HG | 2.29 | 0.00 | 0.00 | 0.00 | 0.00 | 0.00 |
| ACP-H | 0.00 | 2.64 | 2.67 | 2.62 | 2.64 | 2.62 |
| TiO₂ | 2.20 | 2.20 | 2.22 | 2.18 | 2.20 | 2.18 |
| Talc | 4.40 | 4.41 | 4.44 | 4.37 | 4.41 | 4.37 |
| ZnSt | 0.88 | 2.64 | 1.78 | .3.49 | 2.64 | 3.49 |
| ZnO | 1.32 | 0.00 | 0.00 | 0.00 | 0.00 | 0.00 |
| Steric acid | 0.44 | 0.00 | 0.00 | 0.00 | 0.00 | 0.00 |
| BIPB | 0.48 | 0.00 | 0.00 | 0.00 | 0.00 | 0.00 |

To prepare the foam compositions, a Banbury internal mixer was preheated to 70° C., and then the polymers (e.g., ELVAX™ and E/X/Y/Z polymers), TiO₂, talc, and ZnSt were added to the mixer and mixed for 10 minutes. For Comparative Example A, ZnO, steric acid, and BIPB were added to the mixture. The temperature of each of the melts increased to around 90° C. due to shear heating. Following the mixing, the blowing agent (AC 6000 HG for Comparative Example A and ACP-H for Examples 1-5) was added into the mixer and the blend was mixed for 5 minutes, with the temperature of the melts increasing to around 100° C. The compounds were then discharged and transferred to a two-roll mill with a fixed temperature of 70° C. for further cooling and sheeting. The foamable compound sheets were pelletized for foaming.

The pellets were placed into a cuboid-shaped mold and compressed at 175° C. for 500 seconds under vacuum to remove bubbles. After demolding, the foam was placed into a hot tunnel with decreasing temperature (85° C.— 70° C.— 60° C.— 50° C.— 40° C.) setting for annealing. The foam was left overnight before testing.

Density, hardness, resilience, compression set, heat shrinkage, split tear, tensile strength, tensile elongation, tear strength, and expansion ratio for the foam samples were measured. The results are reported in Table 2, below.

TABLE 2
Table 2: Foam Properties

| | | Comparative | Example | Example | Example | Example | Example |
|---|---|---|---|---|---|---|---|
| | Unit | Example A | 1 | 2 | 3 | 4 | 5 |
| Density | g/cc | 0.220 | 0.233 | 0.237 | 0.231 | 0.258 | 0.232 |
| Hardness | Asker C | 62 | 50 | 58 | 62 | 64 | 57 |
| Resilience | % | 47 | 48 | 43 | 40 | 42 | 45 |
| Compression | % | 52 | 57 | 58 | 55 | 50 | 58 |
| Set | | | | | | | |
| Heat | % | 1.07 | −0.40 | −0.29 | −0.05 | −0.02 | −0.50 |
| Shrinkage | | | | | | | |
| Split Tear | N/mm | 2.86 | 2.06 | 2.42 | 3.19 | 2.75 | 3.03 |
| Tensile | MPa | 2.70 | 1.81 | 2.54 | 2.50 | 2.64 | 2.98 |
| Strength | | | | | | | |
| Tensile | % | 287 | 302 | 291 | 302 | 282 | 344 |
| Elongation | | | | | | | |
| Tear | N/mm | 13.13 | 8.68 | 11.02 | 12.62 | 11.76 | 11.31 |
| Strength | | | | | | | |
| Expansion | % | 156 | 150 | 150 | 149 | 148 | 150 |
| Ratio | | | | | | | |

As shown by the results in Table 2, Examples 1-5 exhibit similar properties to Comparative Example A, but lack peroxide and fewer additives. Accordingly, the data demonstrates that various embodiments can achieve comparable foam properties as compared to conventional foams.

Accordingly, various embodiments herein provide a cross-linked foam that exhibits similar foam properties as peroxide crosslinked while exhibiting improved heat shrinkage and processing advantages like lower foaming temperature, shorter foaming time. The cross-linked foam of various embodiments includes a reactive epoxy-containing interpolymer, a chemical blowing agent (such as an AZO blowing agent), and an activator. In particular, the epoxy-containing ethylene interpolymer is a cross-linked epoxy-containing ethylene interpolymer produced by the reaction of the glycidyl methacrylate in the interpolymer and the azo group formed from decomposition of the blowing agent. Without being limited by the theory, the crosslinking of the foam provides improved stability by resisting foam collapse at higher temperatures.

It is further noted that terms like “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A foam formed from a composition, wherein the composition comprises:
at least 40 wt. %, based on the composition, of an E/X/Y/Z epoxy-containing ethylene interpolymer, wherein E is an ethylene monomer and comprises greater than 50 wt. % of the interpolymer, X is an (meth)acrylate, alkyl (meth)acrylate, or vinyl acetate and comprises from 0 to 40 wt. % of the interpolymer, Y is glycidyl methacrylate and comprises 0.5 to 15 wt. % of the interpolymer, wherein the wt. % is based on the total amount of polymerizable monomers, and Z is a copolymer unit derived from comonomers selected from the group consisting of carbon monoxide, sulfur dioxide, and acrylonitrile and comprises from 0 to 10 wt. % of the interpolymer;
from 0.1 to 10 wt. %, based on the composition, of a chemical blowing agent;
from 0.1 to 10 wt. %, based on the composition, of an activator; and
less than 0.05 wt. %, based on the composition, of a curing agent.

2. The foam according to claim 1, wherein X comprises from 1 to 40 wt. % of the interpolymer.

3. The foam according to claim 1, wherein the chemical blowing agent decomposes to liberate one or more azo or nitrogen-containing compounds.

4. The foam according to claim 3, wherein the epoxy-containing ethylene interpolymer is a cross-linked epoxy-containing ethylene interpolymer produced by reaction of the glycidyl methacrylate and the one or more azo compounds or nitrogen-containing compounds liberated by the chemical blowing agent.

5. The foam according to claim 1, wherein the chemical blowing agent is azodicarbonamide.

6. The foam according to claim 1, wherein the activator is a metal stearic acid salt.

7. The foam according to claim 6, wherein the metal stearic acid salt is zinc stearate.

8. The foam according to claim 1, wherein include the foam has a heat shrinkage at 70° C. of less than 0.5%.

9. The foam according to claim 1, wherein the composition is free of peroxides.

10. The foam according to claim 1, wherein the composition consists of the E/X/Y/Z epoxy-containing ethylene interpolymer, the chemical blowing agent, the activator, and the curing agent.

11. A footwear article comprising the foam of claim 1.
